(19) United States
(12) Patent Application Publication
(10) Pub. No.: US 2017/0310173 A1
(43) Pub. Date: Oct. 26, 2017

(54) SYSTEM AND METHOD FOR SELF POWERED GENERATOR

(71) Applicants: Elie N. Dagher, Manchester, NH (US); Nicolas Dagher, Manchester, NH (US); Claire Dagher, Manchester, NH (US)

(72) Inventors: Elie N. Dagher, Manchester, NH (US); Nicolas Dagher, Manchester, NH (US); Claire Dagher, Manchester, NH (US)

(21) Appl. No.: 15/135,159

(22) Filed: Apr. 21, 2016

(51) Int. Cl. H02K 1/27; H02K 7/14; H02K 3/00; H02K 53/00; H02K 11/33

(52) U.S. Cl. CPC H02K 1/27; H02K 53/00; H02K 11/33; H02K 3/00; H02K 7/14

(57) ABSTRACT

An apparatus including an alternator, wherein said alternator is configured to generate power. A shaft coupler for connecting a rotor to said alternator. At least one or more permanent magnets attached to said rotor. At least one or more electromagnets disposed in a close proximity to said at least one or more permanent magnets. A first feedback loop configured to carry said generated power to said at least one or more electromagnets. A second connection from the said feedback loop configured to carry said generated power to an external connection. A battery configured to provide startup power. And, a start power regulator configured to control said startup power supplied from said battery to said alternator and said electromagnets.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to electromagnetic charging devices. More particularly, the invention relates to a self-sustaining electromagnetic charger.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is believed that existing mobile electronic charging devices are limited in their ability to recharge devices connected to them, such as cell phones or smart phones. The limitation may be a result of the use of a battery that discharges its power and typically needs to be recharged for a user to gain benefits from it.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that an individual seeking to charge a battery may do so, by using kinetic energy of the body, which is attached to a device housing magnets within a shelled torus to generate electricity.

Yet another aspect of the prior art, utilizes a rotor and power generator that uses mechanical components powered by a battery. The battery is typically rechargeable and may be the only source of power. The mechanical components may be subject to normal wear and tear

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary device, which may have multiple connection ports, in accordance with an embodiment of the present invention.

FIG. 2 is an internal layered illustration of an exemplary portion of an embodiment device having electromagnets, in accordance with an embodiment of the present invention; and,

FIG. 3 is an internal layered illustration of an exemplary portion of an embodiment device having a startup device, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”, e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

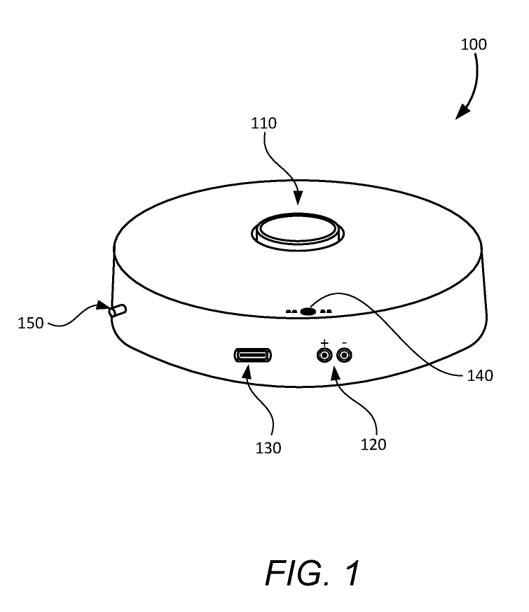

FIG. 1 is an illustration of an exemplary device, which may have multiple connection ports, in accordance with an embodiment of the present invention. In an external view of the present embodiment shown, a device may have a startup button 110. The startup button 110 may be used to power the device and switch it on or off, as will be described in more detail. In the present embodiment, the device may have an external connection for a regulated or unregulated AC or DC output signal 120. The output signal 120 may be connected to any number of external devices, including without limitation, a smartphone, flashlight, camera, drone, electronic razor, pocket fan, headphones, chargers, computing devices or other electronic device. In the present embodiment, the device may have another external connection via a USB port 130. The USB port 130 may connect to any external devices, including without limitation, smartphone, camera, drone, chargers, computing devices, or others via USB cables or microUSB cables. The output signal may be set and regulated at a desired voltage or current.

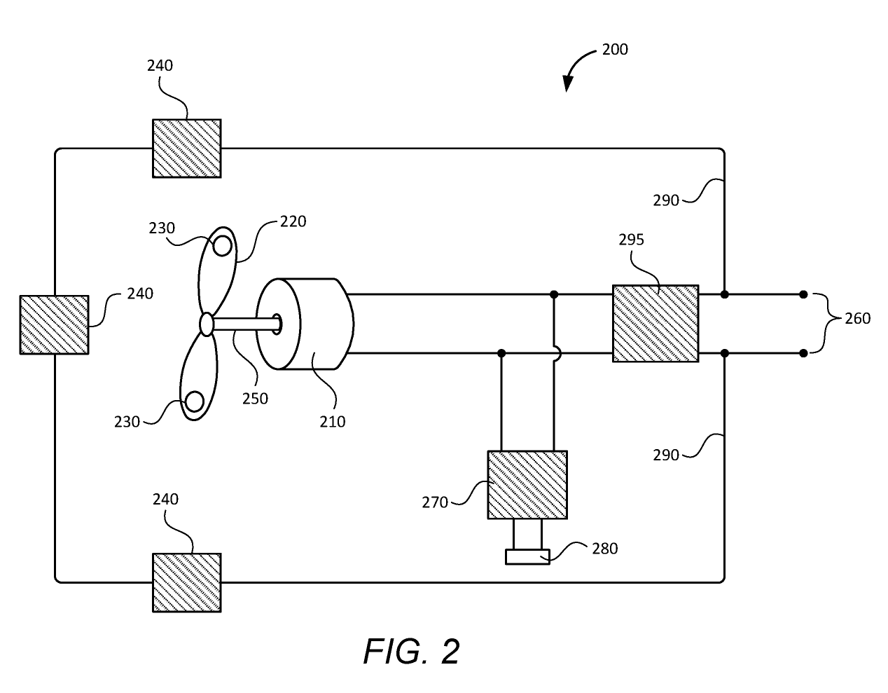

FIG. 2 is an internal layered illustration of an exemplary portion of an embodiment device having electromagnets, in accordance with an embodiment of the present invention. In the present embodiment shown, the device may have an alternator 210. The alternator 210 is connected to a rotor 220. It should be noted that although the embodiment shown has only two blades on the rotor 220, it is contemplated that the rotor 220 may have any number of blades and as many shapes as may be deemed necessary by one of ordinary skill in the art. In the present embodiment, one or more permanent magnets 230 may typically be attached to the rotor 220. In the present embodiment, one or more electromagnets 240 may be set near the permanent magnets 230. The rotor 220 is connected to the alternator 210 via a shaft coupler 250. The output of the alternator 210 may be split into three separate outputs that may be in parallel or in series. In one aspect of the output, the alternator 210 is connected to a regulator 270, which is connected to the USB port 280. In another aspect of the output, the alternator 210 is connected to another regulator 295, which may be connected to one or more outputs. One exemplary output may be unregulated plus or minus pins 260. The plus or minus pins 260 may be connected to any number of external devices for recharging.

The alternator 210 that outputs to a regulator 295, which connects to a feedback loop 290. The feedback loop 290 is connected to the electromagnets 240 to create magnetic fields with polarities opposite or similar to the magnetic polarities of the permanent magnets in order to create pull/push forces which will then cause the rotor to rotate. The regulator 295 monitors power going through the feedback loop 290 towards the electromagnets 240 and external device connected to the plus or minus pins 260.

In the exemplary embodiment, when rotor 220 is spinning, it ideally will cause alternator 210 to generate electricity. The electricity will typically flow through regulator 295 and feedback loop 290, reaching the electromagnets 240. The electricity flowing through the electromagnets 240 typically generates a magnetic field that creates a push/pull effect on the permanent magnets 230. The magnetic field generated keeps the rotor 220 spinning, which causes the alternator 210 to generate more electricity. It should be appreciated by those of ordinary skill in the art that the alternator 210 may also be called a motor. Alternators and motors are similar devices. The devices behave like a motor when power is supplied to them. The devices behave like an alternator when the rotor is spinning. The feedback loop 290 ideally enables the system to increase in speed and power. As the alternator 210 generates more power, the stronger the magnetic field, which is created by the electromagnets 240, becomes and typically the faster the rotor 220 may spin.

The electromagnets 240 may be arranged in different configurations to maximize the rotating speed of the rotor 220. Several different polarity configurations may be used. In an alternative embodiment, a Hall Effect sensor may be added to determine the position of the rotor 220 to determine which electromagnets 240 should be supplied power and in which order to typically improve performance of the device.

In an alternative embodiment, an LED may be attached to the system, so that it may function as a flashlight. An external switch may be added to turn the LED or flashlight on or off.

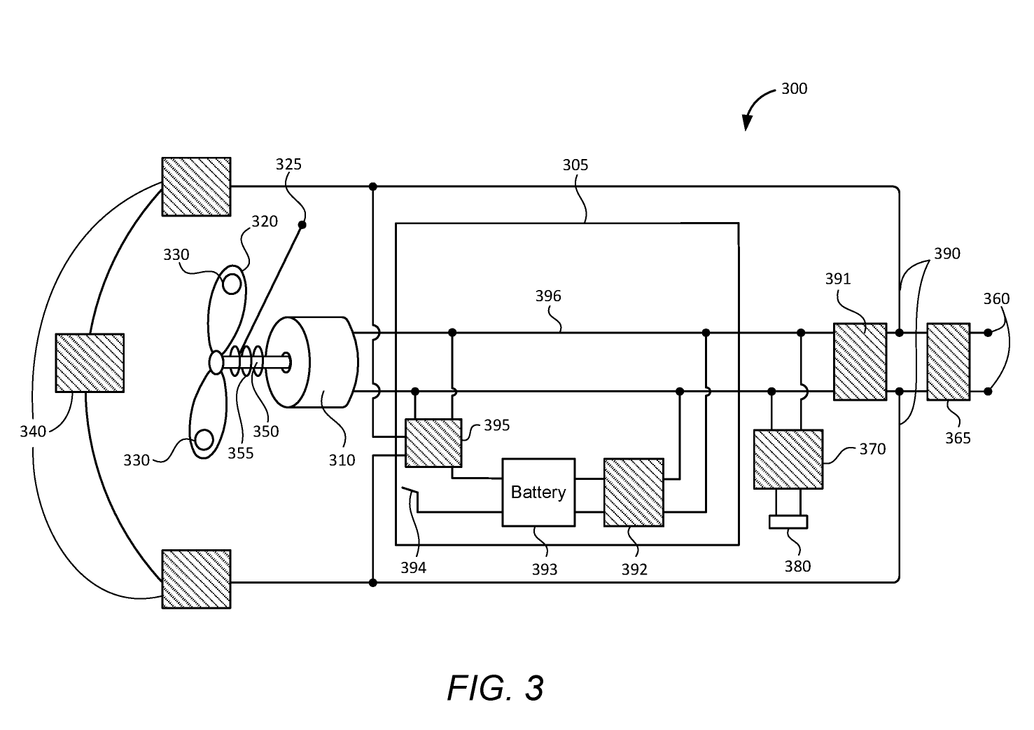

FIG. 3 is an internal layered illustration of an exemplary portion of an embodiment device having a startup device in accordance with an embodiment of the present invention. In an alternative embodiment, a startup system 305 is connected to the electromagnetic charger 300. In the present embodiment, the startup system 305 contains a battery 393. The battery 393 is connected to a start power regulator 395. The start power regulator 395 is connected to an alternator 310 and one or more electromagnets 340, which are also connected to a feedback loop 390. The start power regulator 395 typically regulates power coming from the battery 393 flowing to the alternator 310 and the electromagnets 340. The start power regulator typically allows one-way flow of electricity and prevents any return power going back to the battery 393. This is typically done using a Diode or Transistor. When the electromagnetic charger 300 is turned on, the start power regulator 395 supplies power from the battery 393 to the alternator 310. The alternator 310 is connected to a rotor 320 via a shaft coupler 350. In the present embodiment, one or more permanent magnets 330 are attached to the rotor 320. The rotor 320 may spin in a clockwise or counter-clockwise direction depending on where the plus or minus sides of the battery 393 are attached. In an exemplary aspect, the plus and minus sides of the battery 393 are attached to the plus and minus sides respectively of the alternator 310, which causes the rotor 320 to spin in a certain direction. In another exemplary aspect, the plus and minus sides of the battery 393 are attached to the minus and plus sides respectively of the alternator 310, which causes the motor 320 to spin in the opposite direction.

In a similar setup to the present embodiment, the polarities of the electromagnets 340 may change depending on the orientation of the plus or minus connection of the battery 393 to the electromagnets 340 and the feedback loop 390.

In the present embodiment, the ideal purpose of the startup system 305 is to enable the rotor 320 to start spinning and provide a means for the alternator 310 to begin generating electricity. The Start Power Regulator may supply power to the motor and the electromagnets at the same time. The electromagnets may need to be polarized in the same direction as they will be later. The motor may need to spin the rotor in the same direction as needed later. The rotor may need to pick up momentum so that when Start Power Regulator cut off the power from the battery to the motor while still supplying power to the electromagnets, the electromagnets may keep on exercising the push/pull effect on the already spinning rotor. The purpose is to get the Fan/rotor 320 to start spinning, while also applying magnetic force on it from the electromagnets 340. Once there is enough momentum in the rotor 320 rotation, the power may then be cut off from the Motor 310, while the electromagnets 340 may then keep the rotor 320 on spinning, which in turn, cause the alternator 310 to produce electricity which is then fed back to the electromagnets 340. This momentum is essentially needed to help spin the rotor in case the electromagnets' forces can't provide enough torque to spin the alternator's rotor 320. At this point the motor may start acting as an alternator (since no power is supplied to the alternator, but the rotor is spinning). Once the alternator 310 start generating enough electricity for a self-sustained system, the Start Power Regulator will stop supplying power to the electromagnets 340, and the battery 393 will charge up:

The battery power may be disengaged after a set period of time or when certain criteria is reached, which may include without limitation, a minimum current draw, voltage peak, or rotation speed of the rotor. Once battery power is disengaged, the system 300 may be self-sustained via electricity generated from the alternator 310, which supplies power through a regulator 391, which in turn goes through the feedback loop 390. The electricity through the feedback loop 390 supplies power to the electromagnets 340, which engage in a push/pull relationship with the permanent magnets 330. The regulator 391 provides electricity to unregulated plus or minus pins 360

In an alternative embodiment, a capacitor may be used instead of the battery 393 to start the electromagnetic charger. The capacitor may hold only enough charge to start the alternator 310 until it takes over and generates its own power. In another alternative embodiment, the user of the electromagnetic charger could blow air onto a fan, which would replace the rotor 320. A small hole or elongated cylindrical attachment may be added to the electromagnetic charger to accomplish this feature. In another alternative embodiment, the user may apply manual force. In an exemplary application, the user strikes a spring, torsion spring, or clock spring (which is a flat metal wire in a spiral shape) (355 that applies force to the rotor 320. The user may pull on an external knob (similar to how retractable badge reel works) 325 that is connected to the rotor 320 or shaft coupler 350. It is contemplated the user may turn the knob in a predetermined direction until it locks. Subsequently, the user may push the knob down, which releases the spring and spins the rotor 320 in the direction the electromagnets 340 would typically spin the rotor 320.

In an alternative embodiment, an electronic device including without limitation, a cell phone, computer, or any other electronic device may have a software application that interfaces with the self-powered electromagnetic charger. The software application could connect using any reasonable means, including without limitation, Bluetooth, USB, USB-C, Firewire, Thunderbolt, or over a wired or wireless network. The software application may be used to read and display data including, but not limited to: speed of the rotor 320, power generated (Watts), power consumption, Current (Amps), Voltage, aggregate data about usage, power savings from power generated, or recommendations. It is contemplated that the software application may also be used to start up or shut down the device remotely.

In an alternative embodiment, external features may be added, including without limitation, light indicators, LEDs, flashlight capabilities, transmitters, receivers, Bluetooth, mp3 player, capabilities to communicate with smartphones (iPhones/iOS, Android, Windows, . . . ), LCD display, microUSB cable, lightning cable, or different types of connectors and wires are obvious additions to this invention. In case of the addition of cables (such as microUSB, USB Type-C, or lightning cables), these may be built in retraceable cables.

In an alternative embodiment, the electromagnetic charger may have a slot, based on some common standard that may fit pins from other devices that needs a power source. In other words, allow third party devices to install this invention as a power source for their systems, including without limitation, a portable heater, cooler, external lights and projectors, or cars. In an aspect of the present embodiment, a drone may have a designated area on it to place and connect the electromagnetic charger. It is contemplated that the user may place the charger in the designated area for the drone where it gets locked and secured properly. Once the user is done using the drone, the user can detach the charger and install it on another device that uses the same common standard as the drone did. Alternatively, the user can simply charge their other devices using the common connectors. In an exemplary application, the common connectors may be USB or microUSB.

In an alternative embodiment, multiple electromagnetic chargers may be connected in various orientations or configurations. The electromagnetic chargers may be connected in series or parallel, to create a bigger or stronger generator. In an exemplary aspect, two 5V devices may be connected in series to create a 10V generator. This may be done using custom proprietary pinouts or any other connection reasonably contemplated by one or ordinary skill in the art.

In an alternative embodiment, an external voltage regulator 365 (FIG. 3), which will be controlled by an external know 140 (FIG. 1), may be added to regulate the voltage output at the unregulated plus or minus pins 360. In this way, the user can adjust the output to the desired voltage level, such as 5V, 7V, 10V, or any other voltage output level.

In an alternative embodiment, the electromagnetic charger may be wirelessly turned on and off using a device including without limitation, a smartphone, RF or IR powered remote, computer, or any other device capable of disabling the electromagnetic charger.

In an alternative embodiment, the electromagnetic charger may be adapted to provide wireless charging capability. This ability is also known as inductive charging. In other words, the device doesn't need to be connected to the external device in order to charge it. It is contemplated the user may be able to charge an external device by certain orientations of the electromagnetic charger and the external device. Some orientations of the electromagnetic charger and the external device include without limitation, placing the charger on the device, near the device, or within a certain range of the device.

In an alternative embodiment, the rotor 320, permanent magnets 330, and electromagnets 340, may be replaced with a DC brushed or brushless motor. The DC brushed or brushless motor would connect the alternator 310 to the motor via the shaft coupler 350. When the motor spins the shaft coupler 350 of the alternator 310, the alternator 310 will generate power, which typically feeds back to the motor in a manner that continuously spins the alternator 310. In such a scenario, the DC motor could have a high torque and high RPM to be able to deliver the performance needed. The torque and RPM will be higher or equal to the Alternator's 310 torque and RPM (needed to generate the required output) respectively. In this manner, the DC motor can easily supply the torque and speed needed by the Alternator to start up and generate the desired output voltage

In an alternative embodiment, the electromagnetic charger could be waterproof. This can be accomplished by using any waterproofing technology, which includes without limitation: vacuum sealed housing or invisible Nano coating.

In an alternative embodiment, a funnel would be attached to the rotor 320, which may allow air created by the spinning fan to funnel back on itself to turn the fan even faster.

In an alternative embodiment, the electromagnetic charger may have a timer to start and stop charging and generating electricity. The timer may be set by the user for certain intervals or a set daily schedule. It is contemplated that the user has great flexibility in setting the timer.

In an alternative embodiment, the electromagnetic charger may have various safety features. The safety features include without limitation: a failsafe mechanism to stop generating electricity if it overheats or reaches a certain temperature. A feature for prevention of unintentional button pushing, using two power buttons: one button, which may be a slider, could be used as a primary to tell the device to turn it on and a second button could be used to start the rotor 320. The second button was described above in the startup section. To shut down the system, simply turn off one or only the major power button.

Another safety feature may be the use of a fan, instead of a rotor, which could be useful to cool down the system internally. This feature may use small vents that may be located on the external body of the device to draw air inside the device.

Another safety feature, may be used where a battery is placed at the end of the power line. A failsafe system may be used to prevent overcharging and overheating. This can be accomplished by using a temperature sensor such as, without limitation, a diode temperature sensor or an IC temperature sensor. In addition, it is contemplated that the electromagnetic charger detects overcharging the external device and avoids that result.

Another safety feature, may be that the electromagnetic charger may detect no load is connected after few seconds or minutes. When the charger detects that condition, the system may disable the power feed and turn off.

In an alternative embodiment, the electromagnetic charger may be scaled up or down to produce higher or lower voltage and current draw depending on the need. The electromagnetic charger may be used in a number of products as an internal built-in component or as an externally conntected device via wire or attached in a designated external area. The electromagnetic charger may be used internally or externally for anything that is mobile or non-mobile including without limitation, light fixtures, projectors, satellites, electric displays, heaters, coolers, water filters in remote areas, wireless routers, security cameras, and wireless speakers. Any device that may need some form of charging capability or an external power source, including without limitation, smartphones, laptops, drones, small mobile fridges/coolers, small mobile heaters, small mobile air conditioners, electric cars, electric planes, satellites, backup home generator, civil and military communication systems. It is contemplated the electromagnetic charger may get rid of all wiring needed to install remote devices. The electromagnetic charger may be sold as accessory by cell phone manufacturers or suppliers (i.e. Apple, Samsung, etc.), mobile service providers (i.e. Verizon, T-Mobile, etc.), hardware stores (i.e. Home depot), or any retailer (i.e. Amazon, Walmart, etc.). The electromagnetic charger may be used by the military, space and satellite agencies, NASA, commercial companies, disaster relief groups, and regular consumers. The electromagnetic charger is a general purpose charger that may be used for various purposes that requires charging or to power an electrical device without the need for external power or resources. The electromagnetic charger may be used as a wind turbine that uses electromagnetism to keep wind turbine spinning, instead of wind. The electromagnetic charger may be retained anywhere without limitation in places such as a car, a backpack, a jacket, belt, or even pants pocket.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a self-sustaining electromagnetic charger, according to the present invention will be apparent to those skilled in the art. Various aspects of the invention have been described above by way of illustration, and the specific embodiments disclosed are not intended to limit the invention to the particular forms disclosed. The particular implementation of the self-sustaining electromagnetic charger may vary depending upon the particular context or application. By way of example, and not limitation, the self-sustaining electromagnetic charger described in the foregoing were principally directed to provide a self-sustaining rotor using an alternator to generate electricity that drives electromagnets which power the rotor implementations; however, similar techniques may instead be applied to wireless induction charging, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
an alternator, wherein said alternator is configured to at least generate power;
a rotor connected to said alternator;
at least one or more permanent magnets attached to said rotor;
a shaft coupler for connecting said rotor to said alternator;
at least one or more electromagnets disposed in a close proximity to said at least one or more permanent magnets;
a first feedback loop configured to carry said generated power to said at least one or more electromagnets;
a first regulator configured to regulate said generated power going to said at least one or more electromagnets;
a micro USB configured to provide power to at least an external device from said generated power;
a second feedback loop configured to carry said generated power to said micro USB;
a second regulator configured to regulate said generated power going to said micro USB;
a battery configured to supply startup power;
a start power regulator configured to regulate and control said startup power supplied from said battery to said alternator and said electromagnets:
a first one-way gate configured to deliver said startup power from said battery to said alternator;
a second one way gate configured to deliver said startup power from said battery to said electromagnets; and
an external knob configured to turn said alternator or rotor in case said battery is empty, missing, or not recharging.

2. The device of claim 1, wherein said startup power activates said at least one or more electromagnets to create a magnetic field polarity opposite the magnetic polarity of the permanent magnets to cause the rotor to rotate.

3. The device of claim 1, wherein said alternator comprises a motor.

4. The device of claim 3, wherein said startup power going to said at least one or more electromagnets is disabled after a predetermined amount of time and after said alternator is spinning and generating power.

5. The device of claim 3, wherein said startup power going to said alternator is disabled after a predetermined amount of time after said alternator is generating power.

6. The device of claim 1, wherein said battery comprises a capacitor.

7. The device of claim 1, in which said external knob comprises a spring loaded knob configured to spin said rotor in a predetermined direction.

8. The device of claim 1, wherein as more power generated is by the alternator, the stronger the magnetic field is, the faster the rotor spins.

9. The device of claim 1, in which said rotor comprises a flat disk.

10. The device of claim 1, in which said rotor comprises a fan.

11. The device of claim 1, in which said second regulator comprises an AC to DC power regulator.

12. A system comprising:
an alternator, wherein said alternator is configured to generate power;
a rotor connected to said alternator;
at least one or more permanent magnets attached to said rotor;
a shaft coupler for connecting said rotor to said alternator;
at least one or more electromagnets disposed in a close proximity to said at least one or more permanent magnets;
a first feedback loop configured to carry said generated power to said at least one or more electromagnets;
a first regulator configured to regulate said generated power going to said at least one or more electromagnets;
an external connection configured to output regulated power to an external device from said generated power;
a second feedback loop configured to carry said generated power to said external connection;
a second regulator configured to regulate said generated power going to said external connection;
a battery configured to provide startup power; and
a start power regulator configured to regulate and control said startup power supplied from said battery to said alternator and said electromagnets.

13. The device of claim 12, further comprising:
a first one-way gate configured to deliver said startup power from said battery to said alternator;
a second one-way gate configured to deliver said startup power from said battery to said electromagnets;

14. The device of claim 12, further comprising an external knob configured to turn said alternator or rotor in case said battery is empty, missing, or not recharging, in which said external knob comprises a spring loaded knob configured to spin said rotor in a predetermined direction.

15. The device of claim 12, wherein said startup power going to said at least one or more electromagnets is configured to create a magnetic field polarity opposite the magnetic polarity of the permanent magnets to cause the rotor to rotate, and wherein said startup power going to said at least one or more electromagnets is disabled after a predetermined amount of time after said alternator is spinning.

16. The device of claim 12, wherein said alternator is a motor.

17. The device of claim 12, wherein said startup power going to said alternator is disabled after a predetermined amount of time after said alternator is generating power.

18. The device of claim 12, wherein said battery comprises a capacitor, and in which said rotor comprises at least one of a flat disk and a fan.

19. An apparatus comprising:
means for generating power;
means for connecting a rotor to said power generating means;
means for supplying magnetic field, wherein said magnetic field supplying means is attached to said rotor;
means for producing electromagnetic field, wherein said electromagnetic field producing means being disposed in a close proximity to said magnetic field supplying means;
means for outputting power to an external device from said generated power;
means for carrying said generated power to said electromagnetic field producing means;
means for regulating said generated power going to said electromagnetic field producing means;
means for carrying said generated power to said power outputting means;
means for regulating said generated power going to said power outputting means;
means for supplying startup power; and
means for controlling said startup power supplied to said alternator and said electromagnets.

20. The device of claim 19, further comprising means for turning said power generating means or rotor in case said startup power supplying means is empty, missing, or not recharging.
